(19) United States
(12) Patent Application Publication
(10) Pub. No.: US 2006/0215320 A1
(43) Pub. Date: Sep. 28, 2006

(54) Recording disk cartridge and disk drive

(75) Inventor: Kengo Oishi, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/328,119

(22) Filed: Jan. 10, 2006

(30) Foreign Application Priority Data
Mar. 22, 2005 (JP) 2005-082349

(51) Int. Cl. G11B 23/03

(52) U.S. Cl. 360/133

(57) ABSTRACT

The recording disk cartridge includes a rotary shutter that opens and closes the side opening thereof by rotating within the case; a swing shutter that swings according to the rotational movement of the rotary shutter, and opens and closes the center hole; and a function discrimination member having a reflection face and a filter for discriminating the function of the recording disk cartridge. A band of the filter is selected from a plurality of predetermined bands according to the function of the recording disk cartridge. A disk drive receiving the cartridge has a light emitter emits light and a first receiver near an inlet of the cartridge receives the light from the emitter via the discrimination member and a second light receiver for receiving the light from the emitter via the discrimination member when the cartridge is located where the cartage is drivable.

### BACKGROUND OF THE INVENTION

1. Field of the Invention

The present invention relates to a recording disk cartridge that houses a recording disk medium in a cartridge case and a disk drive for recording data on and reproducing the data from the recording disk cartridge.

2. Description of the Related Art

Conventionally, a recording disk cartridge is known that houses in a cartridge case: a recording disk medium such as a flexible magnetic disk medium where magnetic layers are formed on both faces of a disk-form support body consisting of such a polyester sheet; magneto-optical disk medium; and a phase-change disk medium. These pieces of recording disk media are made to be higher density recording year by year; and their recording track width is becoming narrower and their recording length shorter. Therefore, a read error is apt to occur in a magnetic disk cartridge only if a slight amount of dust intervenes between the magnetic disk medium and a magnetic head. In addition, although the optical disk medium is said to be comparatively strong for dust, in higher recording density, as a result of a numerical aperture of a lens of an optical pickup, it becomes necessary to near the medium and the lens, and after all the read error is apt to occur due to the dust.

As a portion through which dust invades a recording disk cartridge are found an access opening provided at a cartridge case in order to make a magnetic head and an optical pickup access a recording disk medium; and a chucking center hole provided at a center of the cartridge case in order to couple a spindle of a disk drive with the recording disk medium. Then a conventional recording disk cartridge is configured so as to close the access opening and the center hole in no use thereof in order to prevent dust from invading inside of its cartridge case (for example, see Japanese Patent Laid-Open Publication No. 2004-013921, 2002-063778, and 2004-348885).

However, because in the conventional recording disk cartridge a shutter for closing the access opening and the chucking center hole is actuated outside the cartridge case, there is a possibility that the shutter is hooked into other things and opens in any of taking along and keeping the cartridge. In addition, because the conventional recording disk cartridge is designed so that the shutter can easily be contacted from outside, there is also a possibility that the shutter is carelessly opened. Then, because in the conventional recording disk cartridge the access opening is provided on an upper face or/and lower face of the cartridge case in parallel with the recording disk medium, the medium is largely exposed and becomes a state of being easily tainted and damaged when the shutter opens. Furthermore, because in the conventional recording disk cartridge the access opening is provided on the upper face or/and the lower face of the cartridge case, there is also a problem that a rigidity of the cartridge case is lowered and that it is difficult to make the case thinner.

Further, it is desirable that such a recording disk cartridge provides easy-to-see discrimination in functions such as an insert direction into a disk drive, a right face and a wrong face, and a recording capacity.

Consequently, a recording disk cartridge is strongly requested that prevents dust from invading inside of a cartridge case, and recording disk medium from being tainted and damaged as much as possible, and has a higher rigidity with easy discrimination in the functions, and a disk drive used for the recording disk cartridge is requested as well.

### SUMMARY OF THE INVENTION

An aspect of the present invention provides a recording disk cartridge having a recording disk medium and a cartridge case for housing the recording disk medium, and the recording disk cartridge comprises: a base frame that substantially surrounds a radial directional outside of the recording disk medium, configures a sidewalls of the cartridge case, and has a side opening for exposing the recording disk medium to the outside; a lower plate that is disposed below the recording disk medium and configures a lower wall of the cartridge case, wherein a chucking center-hole is formed in order to couple a spindle of a disk drive with the recording disk medium; an upper plate that is disposed above the recording disk medium and configures an upper wall of the cartridge case; a rotary shutter that opens and closes the side opening by rotating within the cartridge case; a swing shutter that is disposed between the recording disk medium and the lower plate and is engaged in the rotary shutter, thereby swings in response to the rotational movement of the rotary shutter, and opens and closes a center hole; a chamfer portion formed at a corner of a front edge regarding an insertion direction of the cartridge case into a disk drive, and a function discrimination member arranged at the chamfer portion.

The function discrimination member is a member that provides discrimination in functions of the recording disk cartridge, such as discrimination in the insertion direction thereof into the disk drive, the right face and the wrong face, and a recording capacity of the recording disk medium.

In accordance with such the recording disk cartridge the side opening that makes the recording disk medium front outside, that is, the access opening for a magnetic head and an optical pickup accessing the recording disk medium are provided at the base frame that forms the sidewall of the cartridge case; and the upper plate and the lower plate configure the upper wall and lower wall of the cartridge case, respectively, and occlude the upper side and lower side of the base frame. This prevents the rigidity of the cartridge case from being lowered due to the formation of the access opening on any of the upper face and the lower face. In addition, because the access opening is formed only at the sidewall, even when a user opens the rotary shutter that opens and closes the opening, she or he can only see a rim of an outer perimeter of the recording disk medium from the opening and it is difficult for her or him to directly touch a recording face of the recording disk medium. Therefore, the recording face of the recording disk medium can be prevented from being tainted and damaged. In addition, because a size of the access opening suffices to be minimized, it is difficult for dust to invade inside of the cartridge case.

In addition, the swing shutter for opening and closing the chucking center hole is positioned between the lower plate and the flexible disk, that is, more inside than the lower plate, and thereby, other things are not hooked into the shutter in any of taking along and housing the recording disk cartridge.

Further, the recording disk cartridge is configured to have a chamfer portion at the corner of the front edge regarding the insertion direction of the cartridge case into a disk drive, and a function discrimination member is arranged at the chamfer portion, so that the disk drive into which this recording disk cartridge is inserted can access the function discrimination member in two directions, namely, a front (an insertion side) of the disk cartridge, and a side direction. Accordingly, the disk drive can easily and appropriately perform the function discrimination recording the recording disk cartridge.

The function discrimination member of the recording disk cartridge may have a light reflection face. When this recording disk cartridge is inserted into a disk drive including a light emitting portion and a light receiving portion for receiving light from the light reflection face, reception of the reflection light by the light receiving portion provides information indicating that the function discrimination portion is located at a predetermined place within the disk drive. Thus, for example, if the light emitting portion and the light receiving portion are arranged in the disk drive to receive the reflection light by the light receiving portion, when the recording disk cartridge is inserted in which the right face and the wrong face thereof are correctly arranged and the insertion direction is correct, erroneously insertion of the recording disk cartridge with respect to the right and wrong faces or the insertion direction results in no detection of the reflection light from the light reflection face. In other words, in the recording disk cartridge, detection of the presence or the absence of the reflection light from the light reflection face provides discrimination in the insertion direction and between the right face and wrong faces.

Further, it is preferable that the light reflection face makes an angle of 45° from the insertion direction of the recording disk cartridge case into the disk drive.

In this recording disk cartridge, the function discrimination member may have a filter for allowing only light having a predetermined wavelength to pass therethrough. In this recording disk cartridge, when the light reflection face of the function discrimination member reflects the light from the light emitting portion of the disk drive, the reflection light is made to include only the predetermined wavelength by the filter of the function decimation member. Thus, in this recording disk cartridge, use of various types of filters having different wavelengths in transmitting light appropriately change the wavelength of the reflection light. In other words, in this recording disk cartridge, for example, previously relating the function such as the recording capacity with the wavelength of the reflection light provides discrimination of the functions of the recording disk cartridge on the wavelength of the reflection light detected by the disk drive.

Further, the recording disk cartridge may be configured such that the rotary shutter includes at an outer circumference a driven gear for providing a rotation motion in response to engagement with a drive gear of the disk drive, at one side of the base frame, a groove for guiding the drive gear to the slave gear, and the chamfer portion is formed at a corner at the other side thereof.

In the recording disk cartridge, the chamfer portion is provided at the corner at the other side where the driven gear and the groove are not formed, so that the disk drive to which the recording disk cartridge is inserted, the function discrimination regarding the recording disk cartridge can be easily and appropriately done.

Meanwhile, although because the disk drive usually accesses a chuck portion of the recording disk medium from below, the side where there exists the center hole for the access is made below for convenience in the upper plate and the lower plate in the present invention, it goes without saying that the lower plate of the invention can be used with being directed in a horizontal direction or upward.

The disk drive according to the present invention receives the above-mentioned recording disk cartridge and includes a light emitting portion for emitting light (a combined ray) including different wavelength components, a light receiving portion for receiving the light from the light emitting portion via the function discrimination member, and a discrimination portion for discriminating functions of the recording disk cartridge on the basis of the wavelength of the light detected by the light receiving portion.

When the recording disk cartridge is inserted into the disk drive, the light emitting portion emits the light toward the function discrimination member of the recording disk cartridge. The light reflected by the light reflection face of the function discrimination member is received by the light receiving portion. The wave lengths received by the light receiving portion can be appropriately changed by the use of various types of filters as mentioned above. For example, previously relating the functions of the recording disk cartridge such as the recording capacity of the recording disk medium with the wavelength of the reflection,light provides the discrimination of the functions of the recording disk cartridge on the basis of the wavelength of the reflection light received by the light receiving portion.

According to the present invention, rigidness of the recording disk cartridge can be improved and invasion of dust particles into the recording disk cartridge and stain of the recording disk medium can be prevented. Further, it is prevented that the swing shutter for opening and closing a center hole to be chucked catches on something outside. In addition, the discrimination of the functions of the recording disk cartridge can be easily performed.

### BRIEF DESCRIPTION OF THE DRAWINGS

The object and features of the present invention will become more readily apparent from the following detailed description taken in conjunction with the accompanying drawings in which:

FIG. 1 is a perspective view of a magnetic disk cartridge and a disk drive according to an embodiment of the present invention;

FIG. 2 is a perspective view of the magnetic disk cartridge viewed from below in a state of an access opening being opened;

FIG. 3 is an exploded perspective view of the magnetic disk cartridge 1;

FIG. 4A is a perspective view of the base frame viewed from above;

FIG. 4B is a perspective view the base frame viewed from below;

FIG. 5 is a sectional view taken along line V-V in FIG. 1;

FIG. 6 is a perspective view of the function discrimination member shown in FIG. 1;

FIG. 7 is a plan view of the magnetic disk cartridge where the upper plate is removed;

FIG. 8 is a perspective view of the rotary shutter viewed from below;

FIG. 9A is a perspective view where a closed state of the rotary shutter is seen from a left front;

FIG. 9B is a perspective view where an opened state of the rotary shutter is seen from the left front;

FIG. 10A is a sectional view of the magnetic disk cartridge to show a state of the rotary shutter being closed; and

FIG. 10B is a sectional view of the magnetic disk cartridge to show a state of the rotary shutter being opened.

The same or corresponding elements or parts are designated with like references throughout the drawings.

### DETAILED DESCRIPTION OF THE INVENTION

Here will be described an embodiment of the present invention in detail, referring to drawings as needed. In the embodiment will be described a case of a magnetic disk cartridge where a magnetic disk medium is adopted as an example of a recording disk medium.

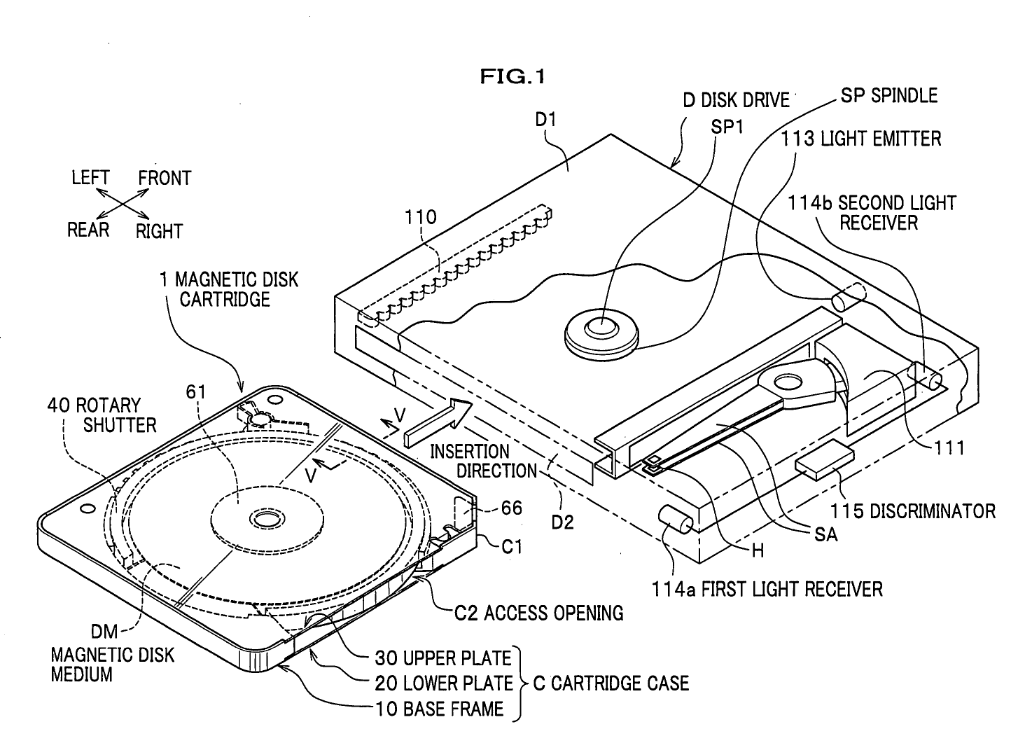

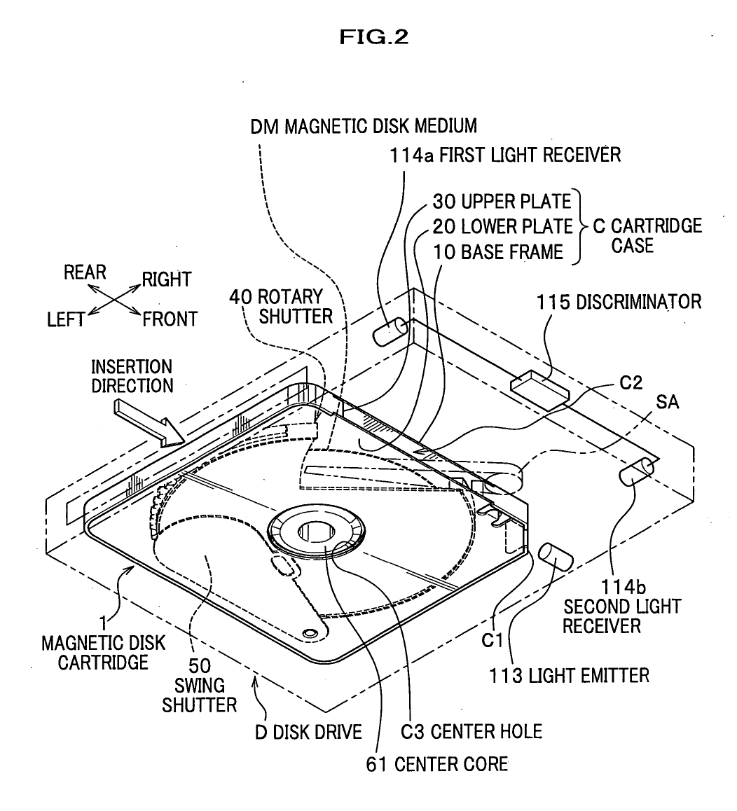

FIG. 1 shows a perspective view of a magnetic disk cartridge 1 and a disk drive D of an embodiment according to the present invention; FIG. 2 shows a perspective view of the magnetic disk cartridge 1 viewed from below in a state of an access opening being opened. Meanwhile, in a description below, with respect to up/down directions, it is assumed that a typical use state of the magnetic disk cartridge is standard, that vertical directions for faces of the magnetic disk medium are the up/down directions for convenience, and that a direction where there exists a center-hole for chucking to expose a center core outside is the down direction. In addition, assuming an insertion direction of the magnetic disk cartridge 1 as a front, the embodiment will be described, using directions of front/rear and left/right shown in FIG. 1. Prior to describing the magnetic disk cartridge, the disk drive will be described.

As shown in FIG. 1, the disk drive D is an apparatus for magnetically recording data on and reproducing the data from the magnetic disk cartridge 1 and comprises a spindle SP for rotating a magnetic disk medium DM, a swing arm SA including magnetic heads H at tips thereof, an actuator 111, a light emitter 113, a first light receiver 114a and a second light receiver 114b, a discriminator 115, a drive gear 110, and a case D1 for housing them.

The swing arm SA is driven by the actuator 111 and thus its tips enter an inside of the cartridge case C through an access opening C2.

Magnetic heads H are arranged at the tips of the swing arm SA to face each other to pinch the magnetic disk medium DM on upper and lower surfaces thereof.

The light emitter 113 is arranged near an inner wall of the case D1 at an opposite side of an insertion inlet D2 of the magnetic disk cartridge 1 (cartridge case C). The light emitter 113 is arranged to emit light toward a function discrimination member 66 of the magnetic disk cartridge inserted through the insertion inlet D2. The light emitted by the light emitter 113 includes a plurality of light components having different wavelengths (bands). The light may be generated by combining a plurality of light rays having different wavelengths (a combined ray).

The first light receiver 114a is arranged near an inner wall at a right-rear side of the case D1. The first light receiver 114a is arranged to receive light traveling in a direction perpendicular to the insertion direction of the magnetic disk cartridge 1.

The second light receiver 114b is arranged near an inner wall at a right-front side of the caser D1. The second light receiver 114b is arranged to receive light traveling in a direction perpendicular to the insertion direction of the magnetic disk cartridge 1.

The discriminator 115 stores a map of recording capacities of magnetic disk media related to various wavelengths (bands) received by the first and second light receivers 114a and 114b. When the first and second light receivers 114a and 114b receive light, the discriminator 115 discriminates a recording capacity (a function of the recording disk medium) inserted into the disk drive D on the basis of the wavelength (band) of the received light with reference to the map.

As shown in FIG. 1, the magnetic disk cartridge 1 is designed to house a magnetic disk medium DM within a cartridge case C. The cartridge case C comprises a base frame 10, a lower plate 20 jointed to a lower side of the base frame 10, and an upper plate 30 jointed to an upper side of the base frame 10.

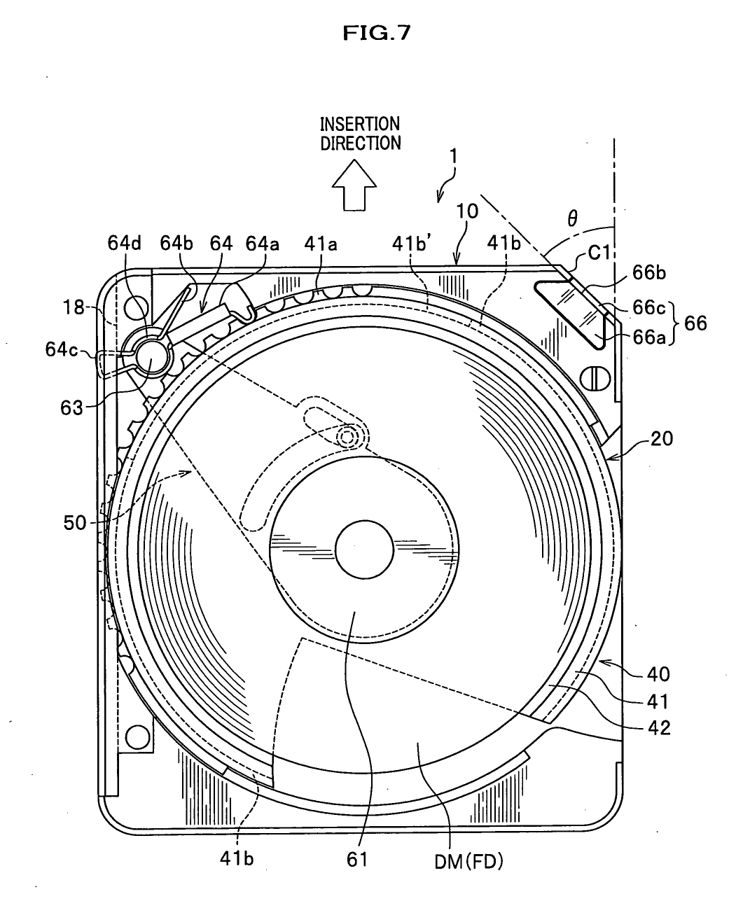

The cartridge case C has an external form which is a substantially rectangular card-form in a plan view. One corner of the rectangle is cut off like a chamfer and forms a chamfer portion C1, and is made a marker for the insertion direction into the disk drive D. The chamfer portion C1 is formed, as shown in FIG. 1, at a corner at a front edge with respect to the insertion direction of the cartridge case C into the disk drive D. In this embodiment, as shown in FIG. 7, the chamfer portion C1 is formed at an opposite side of the groove 18 into which the slave gear 41a fits.

At a side wall of the cartridge case arranged in an orthogonal direction with respect to the insertion direction, namely, in FIG. 1, at a right side wall of the cartridge case C is formed the access opening C2 as a side opening for exposing the magnetic disk medium DM to the outside. The swing arm SA, which the disk drive D has and which has the magnetic heads H at its tips, proceeds inside the cartridge case C from the access opening C2 and accesses the magnetic disk medium DM.

The access opening C2 is closed by a rotary shutter 40 in no use of the magnetic disk cartridge 1, for example, in keeping the cartridge 1, and is opened in use by rotating the shutter 40.

As shown in FIG. 2, at a center of a lower side of the cartridge case C is formed a center hole C3 for chucking to couple a spindle SP (see FIG. 1) of the disk drive D with the magnetic disk medium DM. The center hole C3 is closed by a swing shutter 50 in no use of the magnetic disk cartridge 1, is opened by swinging the swing shutter 50 in use, and exposes a center core 61 (chuck portion 61a) outside, the core 61 having the chuck portion 61a which the magnetic disk medium DM has.

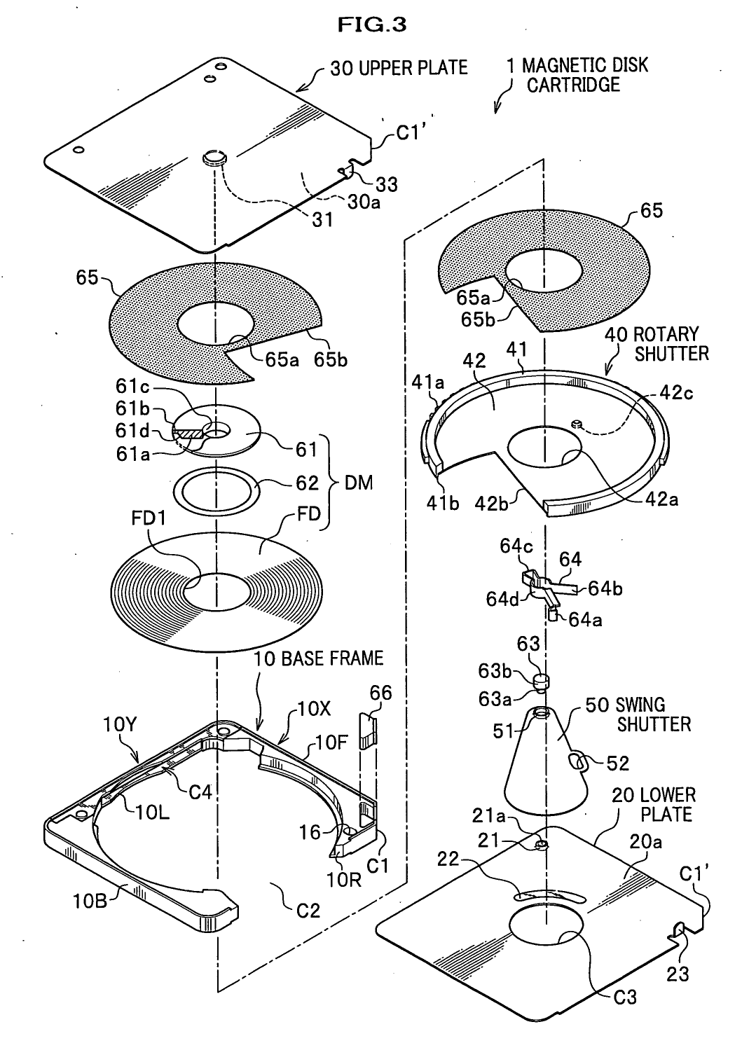

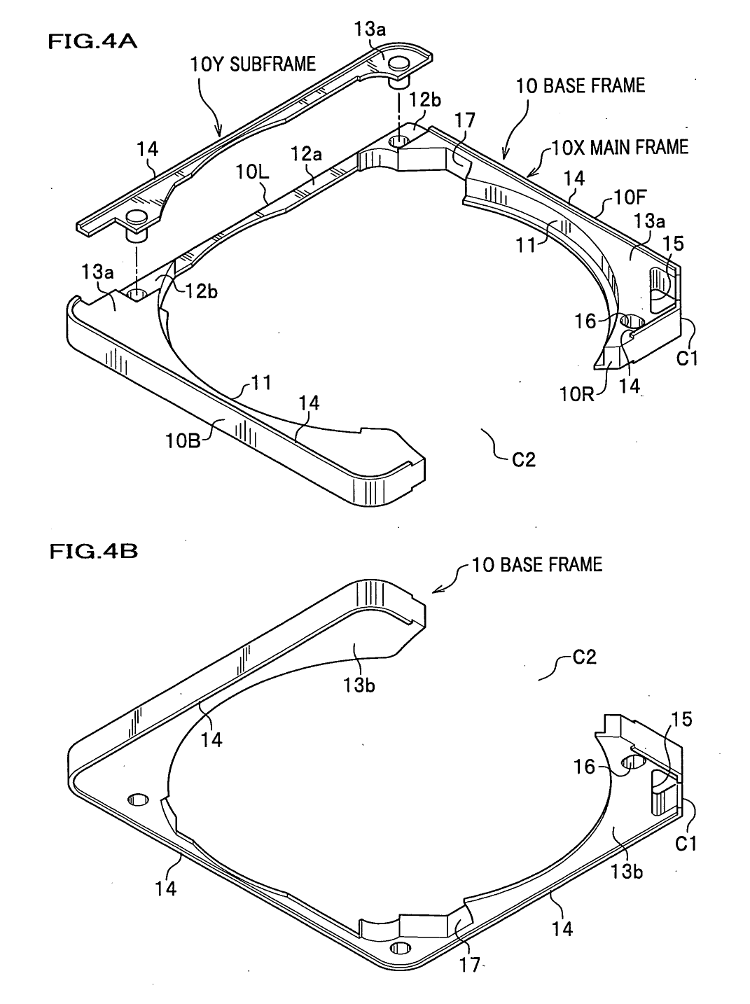

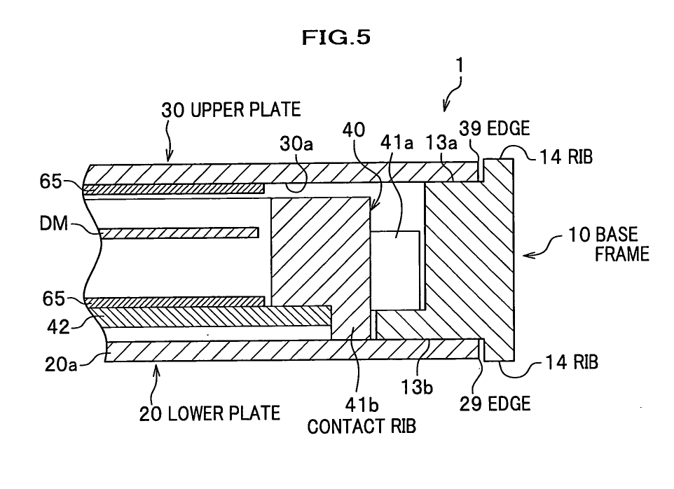

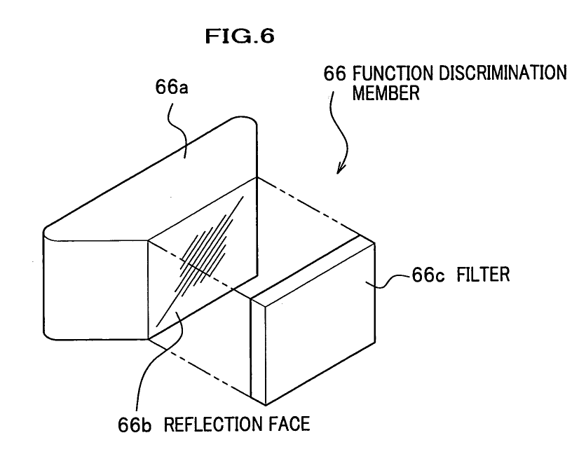

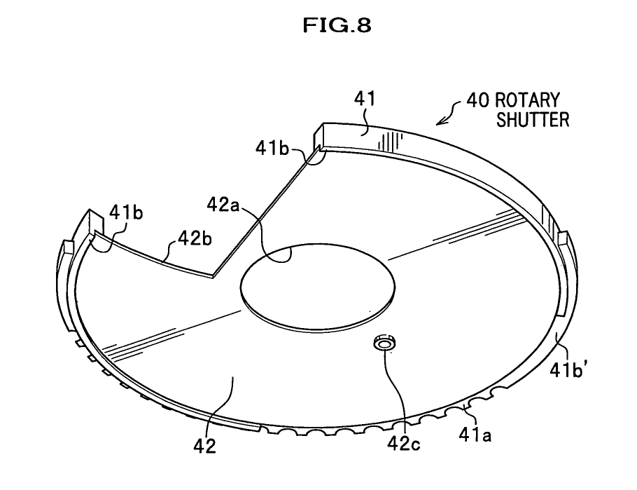

Next will be described the magnetic disk cartridge 1 in detail, referring to FIGS. 3 to 8. FIG. 3 is an exploded perspective view of the magnetic disk cartridge 1. FIGS. 4A and 4B show enlarged exploded perspective views of the base frame 10; FIG. 4A is the perspective view of the base frame 10 viewed from above; and FIG. 4B is the perspective view of the base frame 10 viewed from below. In addition, FIG. 5 is a sectional view taken along a line V-V in FIG. 1; FIG. 6 is a perspective view of the function discrimination member. FIG. 7 is a plan view of the magnetic disk cartridge where the upper plate is removed. FIG. 8 is a perspective view of the rotary shutter viewed from below.

As shown in FIG. 3, the base frame 10 is a C-letter form member in which one edge of a rectangular frame substantially surrounding the magnetic disk medium DM is cut off. To be more precise, the access opening C2 is formed at a right edge 10R. Because the access opening C2 is enough if it is opened at the side portion of the base frame 10, it is not always necessary to form the opening C2 by cutting off one edge, and for example, it is also available to form the opening C2 by thinning part of the edge or providing a slit at the side portion of the edge.

As shown in FIG. 4A, an inner perimeter of the base frame 10 has a cylindrical inner wall 11 matching an outer perimeter of the rotary shutter 40, and the inner wall 11 supports the rotary shutter 40 so as to be rotatable. A left-front part out of the inner perimeter of the base frame 10 is depressed more outside than the cylindrical inner wall 11. The depressed portion is a spring housing portion 17 for housing a lock spring 64 described later.

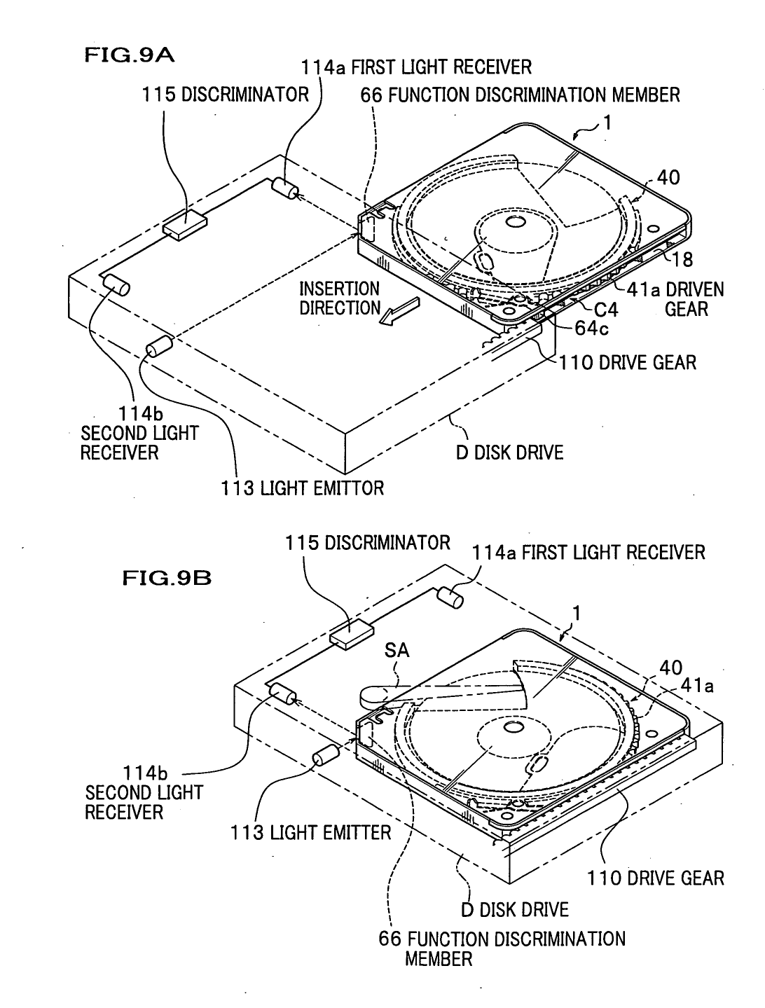

The base frame 10 is designed to be divided into a main frame 10X and a subframe 10Y. The subframe 10Y is a slit-like member configuring an upper side of the shutter actuation opening C4. A left edge 10L of the main frame 10X corresponds to the subframe 10Y, and is formed to be thinner in order to form the shutter actuation opening C4 (the left edge 10L is assumed to be a “thin piece portion 12a ”). At both ends of the left edge 10L of the main frame 10X are formed joint pedestals 12b higher than the thin piece portion 12a by one step. By connecting the subframe 10Y to the joint pedestals 12b, the shutter actuation opening C4 like the slit is formed between the thin piece portion 12a and the subframe 10Y (see FIG. 3). In addition, seen from outside, both ends in front/rear directions of the shutter actuation opening C4 are designed to be a groove 18 of a predetermined width continuing into the shutter actuation opening C4 (see FIG. 9A).

Meanwhile, a height of the joint pedestals 12b is set so that an upper face 13a of the subframe 10Y has the same height as upper faces 13a of the main frame 10X. In addition, in the embodiment although the base frame 10 is designed to connect two members of the main frame 10X and the subframe 10Y, they may also be integrally molded and be designed to be divided into not less than three members.

In addition, at rims of an outer perimeter of the base frame 10 are formed ribs 14 across substantially all outer perimeter toward up/down directions. Heights of the ribs 14 from the upper faces 13a and lower face 13b of the base frame 10 are designed to be the same as or higher than each thickness of the lower plate 20 and the upper plate 30. Therefore, if the lower plate 20 and the upper plate 30 are joined with the base frame 10, an edge 29 of the lower plate 20 and an edge 39 of the upper plate 30 are concealed by the ribs 14 as shown in FIG. 5, and result in not being hooked into the edges 29 and 39 in handling the magnetic disk cartridge 1. Therefore, it becomes difficult for the lower plate 20 and the upper plate 30 to peel off from the base frame 10.

From such meaning, it is preferable that the heights of the ribs 14 from the respective upper faces 13a and lower face 13b of the base frame 10 are higher than respective thicknesses of the upper plate 30 and the lower plate 20.

As shown in FIG. 4A, at the chamfer portion C1 of the base frame 10 is formed a dove tail depression 15 of which a width becomes wider as it goes back. A function discrimination member 66 is stored in the depression 15.

The function discrimination member 66 is a member for discriminating the functions of the magnetic disk cartridge 1, namely, discrimination in the insertion direction of the magnetic disk cartridge 1 into the disk drive D, the right and wrong sides (upper and lower sides) thereof, and the recording capacity of the magnetic disk medium DM. The function discrimination member 66 comprises, as shown in FIG. 6, a body 66a and a filter 66c. At an interface between the body 66a and the filter 66c is formed a light reflection face 66b which makes an angle θ of 45° from the insertion direction of the cartridge case C into the disk drive D (see FIG. 1). On the light reflection face 66b is arranged the filter 66c as shown in FIG. 6. The filter 66c transmits only light having a predetermined wavelength (band) corresponding to the recording capacity therethrough. As a material of the body 66a, for example, plastic is available, and the light reflection face 66b can be formed by bright plating at a predetermined place of the body 66a to provide mirror finish.

As shown in FIG. 4A, a backward place of the depression 15 of the base fame 10, is formed a connection through hole 16 extending upwardly and downwardly. The connection through hole 16 is used when the base frame 10 is connected to the lower plate 20 and the upper plate 30.

As a material of the base frame 10, in the present embodiment, a resistant-to-wear resin such as Polyoxyethylene is selected in consideration of a complicated configuration and easiness in shaping. However, metal, ceramics or the like may be selected.

As shown in FIG. 3, the lower plate 20 is a substantially rectangular plate member configuring a lower wall of the cartridge case C and has at a center thereof the center hole C3 for exposing the center core 61 outside. A size of the lower plate 20 in the plan view is slightly larger than that of the rotary shutter 40, and the outer perimeter of the rotary shutter 40 is positioned more inside than the rim portion of the lower plate 20. At the right-front corner of the lower plate 20 is formed a chamfer portion C1′, imitating the chamfer portion C1. In addition, in the upper face 20a of the lower plate 20, in the vicinity of the left-front corner are formed a protrusion 21 for supporting the swing shutter 50 to be able to swing; and an evasion groove 22 for evading an interference with an engagement protrusion 42c which the rotary shutter 40 has.

The protrusion 21 is formed into a cylindrical form by barring process. Outside the protrusion 21 is fitted a bearing 51 of the swing shutter 50, and in an inner cylindrical portion 21a is fitted a pull-out stopper pin 63.

The evasion groove 22 is positioned on concentric arc with the center hole C3. This is because the engagement protrusion 42c concentrically rotates with center of the cartridge case C (center of the magnetic disk medium DM), following a rotational movement of the rotary shutter 40. A depth of the evasion groove 22 may have a depth that can evade an interference with the engagement protrusion 42c. Meanwhile, in a case that the upper face 20a of the lower plate 20 (equivalent to an inner face of the cartridge case C) is sufficiently smooth, a friction by an abrasion between the engagement protrusion 42c and the lower plate 20, and a wear powder does not occur, the evasion groove 22 may not be provided.

In the vicinity of the right-front of the lower plate 20 is formed a joint claw portion 23. The portion 23 generates a joint force of the base frame 10 and the lower plate 20 by being pressed into the joint through hole 16 of the base frame 10. Although as a joint of the base frame 10 and the lower plate 20 there exist methods such as use of an adhesive, pressed-fit-in of the lower plate 20 and the ribs 14, and thermal caulking after forming a caulking protrusion at the base frame 10 and fitting it in an appropriate opening of the lower plate 20, a method thereof is not specifically limited.

The upper plate 30 is a substantially rectangular plate member configuring the upper wall of the cartridge case C, and at a right-front corner thereof the chamfer portion C1′ is formed, imitating the chamfer portion C1. A size of the upper plate 30 in the plan view is slightly larger than that of the rotary shutter 40, and the outer perimeter of the rotary shutter 40 is positioned more inside than the rim portion of the upper plate 30. At a center of a lower face 30a of the upper plate 30 is formed a protrusion 31 for fixing the center core 61 in no use of the magnetic disk cartridge 1. In addition, in the vicinity of the right-front corner of the upper plate 30 is formed a joint claw portion 33 protruding downward, corresponding to the joint through hole 16. The joint claw portion 33 generates a joint force of the base frame 10 and the upper plate 30 by being pressed into the joint through hole 16 of the base frame 10. A joint of the base frame 10 and the upper plate 30 can also be performed by other methods same as that of the base frame 10 and the lower plate 20.

To the lower face 30a of the upper plate 30, a portion equivalent to an inner face of the cartridge case C, are affixed liners 65 for cleaning a flexible disk FD. As a material of the liners 65 are preferably used a non-woven cloth, a sheet where an ultra high molecular polyethylene is foamed, and the like. The liners 65 are a circular sheet-form member and has at center thereof a circular through hole 65a matching a size of the center core 61. In addition, matching a movement range of the swing arm SA, a notch 65b is formed for preventing an interference with the swing arm SA.

Although the materials of the lower plate 20 and the upper plate 30 are not specifically limited, a needed rigidity thereof can be ensured, even if they are thin, by configuring at least one or preferably both with metal, for example, stainless steel.

In addition, the base frame 10, the lower plate 20, and the upper plate 30 are not configured as respective separate members; but the base frame 10 and the lower plate 20 may also be integrally molded by a resin, an aluminum alloy, and a magnesium alloy; and the base frame 10 and the upper plate 30 may also be integrally molded by these materials.

Furthermore, in a case that a form of the base frame 10 is complicated or has an undercut form, it is also available to integrally mold one part of the base frame 10, for example, the main frame 10X and the lower plate 20; and to integrally mold the other part of the base frame 10, for example, the subframe 10Y and the upper plate 30. Thus, by designing the base frame 10 as a divided configuration, die-cutting is made smooth, and thereby it is enabled to improve a form accuracy of a product.

The rotary shutter 40 comprises a C-letter shutter member 41 and a reinforcement plate 42 jointed to a lower side of the member 41.

The shutter member 41 is a member formed by injection-molding, for example, a resin, wherein as shown in FIG. 7, a driven gear 41a is formed across about one third of an outer perimeter thereof. The driven gear 41a is exposed outside from the shutter actuation opening C4, and engages with a drive gear 110 (see FIG. 1), which the disk drive D has, when the magnetic disk cartridge 1 is inserted in the disk drive D. Accordingly, according to an insertion movement of the magnetic disk cartridge 1, it is enabled that the rotary shutter 40 is rotated by the drive gear 110 and is opened.

As shown in FIG. 7, in the shutter member 41 a contact rib 41b is formed along a lower rim of an outer perimeter thereof. A lower end face of the contact rib 41b contacts and slides on the lower plate 20 on a constant circumference (see FIG. 5, and meanwhile, the contact rib 41b is shown in a displacement thereof), and thereby, it is enabled that the rotary shutter 40 smoothly rotates for the lower plate 20. However, the contact rib 41b is not formed at whole circumference of the shutter member 41, that is, a definite range opposing a portion cut off like a C-letter, wherein a window portion 41b′ is formed. The window portion 41b′ is formed so that the shutter member 41 does not interfere with a movement of the swing shutter 50. To be more precise, as shown in FIG. 7, because the swing shutter 50 is supported outside a radial direction of the shutter member 41 through a shaft and swings between the rotary shutter 40, (shutter member 41) and the lower plate 20, an interference between the swing shutter 50 and the shutter member 41 (contact rib 41b) is prevented by cutting off part of the contact rib 41b that is a contact portion of the lower plate 20 and the shutter member 41. Thus a smooth movement of the swing shutter 50 is enabled.

Meanwhile, although the contact rib 41b is not limited to one formed as a continuous rib and can be formed like an intermittent protrusion, the rib 41b is preferably like the continuous rib in order to prevent dust from invading the cartridge case C from outside.

As shown in FIG. 3, the reinforcement plate 42 is a substantially circular member consisting of a metal plate, for example, such as stainless steel, and comprises a center hole 42a formed at center thereof for inserting through the center core 61, a cutoff 42b matching the movement range of the swing arm SA, and the engagement protrusion 42c protruding downward (side of the swing shutter 50). To an upper face of the reinforcement plate 42 is affixed the liner 65 which is the same as one affixed to the upper plate 30.

The reinforcement plate 42 is a member for reinforcing a rigidity of the shutter member 41 and forming an engagement portion (engagement protrusion 42c in the embodiment) for transmitting a movement of the rotary shutter 40 to the swing shutter 50. If the shutter member 41 has a sufficient rigidity and the engagement portion for engaging in the swing shutter 50, the reinforcement plate 42 is not always necessary.

In addition, because the center hole 42a is enough if the center core 61 passes through it, it may be formed larger than in the embodiment, and for example, may also be an opening continuous with the cutoff 42b.

Furthermore, because the cutoff 42b is provided for facilitating the swing arm SA to proceed into the cartridge case C, it is not always necessary if there exists a space for the swing arm SA proceeding into the cartridge case C.

The swing shutter 50 is a member for opening and closing the center hole C3 of the lower plate 20 as shown in FIG. 3, and is equipped between the lower plate 20 and the rotary shutter 40. The swing shutter 50 is a substantially sectorial plate formed narrower at a base side and wider at a tip side, and the wider portion at the tip has a sufficient size for closing the center hole C3.

At the base of the swing shutter 50 is formed the bearing 51 molded into a cylindrical form. The bearing 51 fits outside the protrusion 21 of the lower plate 20; the swing shutter 50 is swingably supported by the lower plate 20 through a shaft. The pull-out stopper pin 63 is fitted in the inner cylindrical portion 21a of the protrusion 21, and thereby, the swing shutter 50 fitted outside the protrusion 21 of the lower plate 20 is prevented to drop off from the lower plate 20. Meanwhile, the pull-out stopper pin 63 comprises a pin portion 63a and a head portion 63b, and an outer perimeter of the head portion 63b is designed to be an approximately same diameter as that of the bearing 51.

In the swing shutter 50 is formed an engagement hole portion 52 like a substantially ellipse opening hole. The engagement hole portion 52 engages in the engagement protrusion 42c and plays a function of transmitting the rotational movement of the engagement protrusion 42c to the swing shutter 50. Although the engagement protrusion 42c engaged in the engagement hole portion 52 has a possibility that a tip (lower end) of the protrusion 42c slightly protrudes below the engagement hole portion 52, a smooth movement of the rotary shutter 40 is not blocked because the protruded portion is housed in the evasion groove 22.

In the embodiment, although the engagement hole portion 52 is formed as a through hole, it may also be an engagement portion not limited to the through hole. For example, the engagement hole portion 52 may be formed as not the through hole but a groove (engagement groove portion), and the groove and the through hole are opened to the rim portion of the swing shutter 50. In addition, although the engagement of the rotary shutter 40 and the swing shutter 50 is performed by the engagement protrusion 42c of the shutter 40 and the engagement hole portion 52 of the swing shutter 50, the relation of the protrusion/depression may be reversed. In other words, it is also available to provide the swing shutter 50 with an engagement protrusion protruded toward the rotary shutter 40 and to form in the rotary shutter 40 an engagement hole portion or engagement groove for engaging in the engagement protrusion.

The outer perimeter of the head portion 63b of the pull-out stopper pin 63 and the bearing 51 are designed like one continuous shaft by being formed to be a same diameter, and the continuous shaft supports the lock spring 64 for stopping an unneeded rotation of the rotary shutter 40 in no use of the magnetic disk cartridge 1.

The lock spring 64 comprises a lock leg portion 64a, a spring leg portion 64b, a lock release leg portion 64c, and a bearing portion 64d for making the pull-out stopper pin 63 support these through the shaft. In the lock spring 64, as shown in FIG. 7, a tip of the lock leg portion 64a engages in the driven gear 41a of the shutter member 41; the spring leg portion 64b abuts on the inner perimeter of the base frame 10, to be more precise, the inner wall of the spring housing portion 17. Then in a disposition of the lock release leg portion 64c fronting from the shutter actuation opening C4 to the outside of the cartridge case C, the bearing portion 64d of the lock spring 64 is fitted outside the pull-out stopper pin 63 and the bearing 51 (see FIG. 3). In the state of FIG. 7, the spring leg portion 64b generates an energizing force between itself and the inner wall of the spring housing portion 17, generates a clockwise torque pushing the lock leg portion 64a toward the driven gear 41a, and the lock spring 64 locks the rotation of the rotary shutter 40. On the other hand, when the magnetic disk cartridge 1 is inserted in the disk drive D, the drive gear 110 abuts on the lock release leg portion 64c and rotates the lock leg portion 64a counterclockwise in FIG. 7, and thereby, the lock spring 64 is designed to release the lock of the rotary shutter 40.

As shown in FIG. 3, the magnetic disk medium DM comprises the flexible disk FD and the center core 61.

The flexible disk FD is a disc form having a circular opening FD1 at center thereof, and is generally designed to be provided with a magnetic layer on both faces or one face of a support body consisting of a resin film and the like such as polyester. As a material and layer configuration of the support body and the magnetic layer can be used conventionally known ones, selecting as needed; they are not specifically limited.

The center core 61 is a member jointed to the opening FD1 by an affixation member 62 and having a rigidity to some extent. The center core 61 is generally composed of a magnetic material such as magnetic stainless steel so that the spindle SP of the disk drive D can be attracted by magnetism.

The center core 61 comprises the chuck portion 61a of a conical trapezoid form, and a flange portion 61b extending outside a radial direction from a larger diameter portion of the chuck portion 61a. In the chuck portion 61a, at center thereof is formed a center hole 61c penetrated in the up/down directions. The center hole 61c is formed to be a size that can engage in a center protrusion SP1 (see FIG. 1A) of the spindle SP in order to match a center with the spindle SP. In addition, a size of the center hole 61c also corresponds to that of the protrusion 31 of the upper plate 30. A conical face 61d of an outer perimeter of the chuck portion 61a abuts on the swing shutter 50 when the shutter 50 closes, and becomes an engagement slant for pushing the center core 61 itself into the cartridge case C.

The center core 61 is disposed, making a smaller diameter side of the chuck portion 61a downside, and the flexible disk FD is affixed from downside in the flange portion 61b, that is, a side where the chuck portion 61a protrudes.

The magnetic disk cartridge 1 thus configured is used as follows.

FIGS. 9A and 9B show movements of the rotary shutter 40; FIG. 9A is a perspective view where a closed state of the rotary shutter 40 is seen from a left front; and FIG. 9B is a perspective view where an opened state of the rotary shutter 40 is seen from the left front.

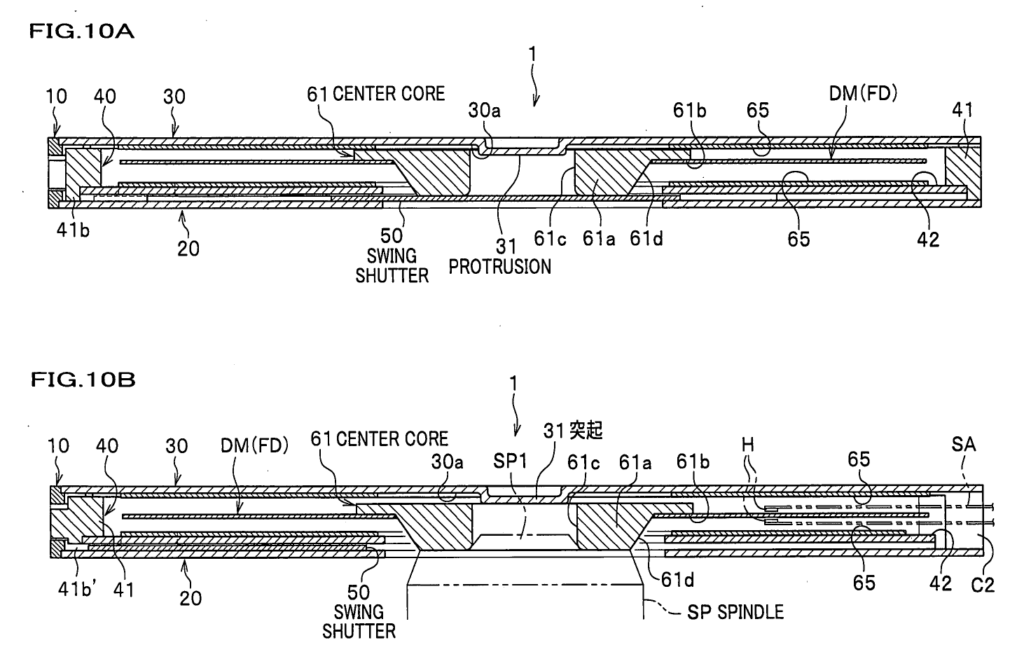

In addition, FIGS. 9A and 9B show perspective views of the magnetic disk cartridge 1; FIG. 9A shows an operation in which light from the light emitter 113 illuminates the first light receiver 114a through the function discrimination member 66; and FIG. 9B shows an operation in which light from the light emitter 113 illuminates the second light receiver 114b through the function discrimination member 66. FIGS. 10A and 10B show sectional views of the magnetic disk cartridge 1; FIG. 10A is a state of the rotary shutter 40 being closed; and FIG. 10B is a state of the rotary shutter 40 being opened.

In the magnetic disk cartridge 1, as shown in FIG. 1, the rotary shutter 40 closes the access opening C2 in no use of the cartridge 1. Then as shown in FIG. 7, the tip of the lock leg portion 64a of the lock spring 64 engages in the driven gear 41a of the shutter member 41, and thereby, the rotary shutter 40 is locked and does not open due to a vibration and the like from outside. Accordingly, it is difficult for dust to invade inside of the cartridge case C and an error is suppressed in recording/reproducing data into the flexible disk FD. Furthermore, as shown in FIG. 10A, the center hole 61c of the center core 61 engages in the protrusion 31 formed on the lower face 30a of the upper plate 30, and thereby, a shift in a diametrical direction of the flexible disk FD is suppressed, and the flexible disk FD is not damaged.

When the magnetic disk cartridge 1 is inserted in the disk drive D, it is inserted, making it front an insertion direction shown in FIG. 1. Then according to the insertion movement, as shown in FIG. 9A, the drive gear 110 of the disk drive D proceeds into the groove 18, abuts with the lock release leg portion 64c of the lock spring 64, and releases the engagement of the lock leg portion 64a and the driven gear 41a.

The light emitter 113 emits the light (combined light) toward the light reflection face 66b (see FIG. 6) of the function discrimination member 66. The light reflection face 66b reflects the light toward the first light receiver 114a, in which the filter 66c of the function discrimination member 66 (see FIG. 6) transmits only the light component having the predetermined wave length out of the emitted light. The discriminator 115 detects the light received by the first light receiver 114a.

On the other hand, when the disk cartridge 1 is inserted into the disk drive D upside down (with a wrong face) or inserted in a reverse direction, the light reflection surface is not irradiated with the light from the light emitter 113, so that the discriminator 115 does not detect reception of the light. In other words, in the magnetic disk cartridge 1 provides discrimination in the insertion direction thereof into the disk drive D and in a right face, namely, upper and lower sides thereof by detecting the presence or the absence of the reflection light from the light reflection face 66b.

The discriminator 115 detects the recording capacity (function of the recording disk medium) of the magnetic disk medium DM mounted on the disk drive D by discrimination on the basis of the wavelength of the light received by the first light receiver 114a with reference to the above-mentioned map.

When proceeding further back into the groove 18, as shown in FIG. 9B, the drive gear 110 engages with the driven gear 41a and rotates the driven gear 41a, that is, rotates the rotary shutter 40.

If the rotary shutter 40 rotates, the engagement protrusion 42c (see FIG. 3) thereof engages with the engagement hole portion 52 (see FIG. 3) of the swing shutter 50, pushes and moves the swing shutter 50, and thus swings the shutter 50 clockwise in FIG. 7. By the swing shutter 50 being swung, the center hole C3 opens, and as shown in FIG. 2, the center core 61 is exposed outside from the center hole C3.

At this time, because the rotary shutter 40 slidingly contacts the lower plate 20 at the contact rib 41b formed along a circumference, it smoothly rotates. In addition, although the swing shutter 50 rotates between the rotary shutter 40 and the lower plate 20, the swing shutter 50 can swing without interfering the contact rib 41b while maintaining the smooth rotation of the rotary shutter 40 because the swing shutter 50 swings in a range of the window portion 41b′, where the contact rib 41b is cut off. Then as shown in FIG. 10B, the center core 61 is detached from the protrusion 31 of the upper plate 30 and can freely move. Simultaneously, the opening of the shutter member 41 matches the access opening C2 by the rotation itself of the rotary shutter 40, and thus the flexible disk FD is made to front outside from the opening C2.

As shown in FIG. 9B, the light reflected by the light reflection face 66b of the function decimation member 66 because the light emitter 113 emits the light toward the light reflection face 66b of the function decimation member 66 is directed to the second light receiver 114b. The discriminator 115 provides discrimination in the insertion direction and the right face of the magnetic disk cartridge 1 when the magnetic disk cartridge 1 is inserted into the disk drive D in a similar way when providing discrimination on the basis of the light received by the first light receiver 114a. Further, the discriminator 115 provides discrimination in the recording capacity (the function of the recording disk medium) of the magnetic disk medium DM mounted on the disk drive D on the basis of the wavelength of the light received by the second light receiver 114b. Thus, the disk drive D can provides discrimination of the magnetic disk cartridge when any one of the first light receiver 114a and the second light receiver 114b becomes unusable.

Furthermore, in the disk drive D, the second light receiver 114b is set to have such a position thereof as to receive the reflection light from the light reflection surface when the magnetic disk cartridge 1 is pushed into the disk drive D until the rotary shutter 40 and the swing shutter 50 are fully opened. The disk drive D can discriminates whether the rotary shutter 40 and the swing shutter 50 are opened in accordance with whether the light received by the second light receiver 114b can be detected.

Then, the spindle SP of the disk drive D couples the center core 61 by magnetic attraction, and holds the magnetic disk medium DM. At this time the center protrusion SP1 of the spindle SP engages in the center hole 61c of the center core 61, and thereby, the center is matched. In addition, the flexible disk FD is substantially positioned at center in the up/down directions (thickness directions) of the cartridge case C. Therefore, when the magnetic disk medium DM is rotated, an air flow above/below the flexible disk FD becomes stable, and a face vibration of the disk FD is suppressed.

Next, the magnetic disk medium DM starts to rotate by the rotation of the spindle SP. The swing arm SA of the disk drive D proceeds into the cartridge case C from the access opening C2 opened at a right side of the magnetic disk cartridge 1, and the magnetic heads H provided at the swing arm SA are loaded on the flexible disk FD.

After data recording/reproducing is performed by the magnetic head H, the swing arm SA retracts from the cartridge case C and the head H is unloaded. In addition, the spindle SP is detached from the center core 61.

When the magnetic disk cartridge 1 is removed from the disk drive D, a reverse movement for the insertion is performed. In other words, by a movement of pulling the magnetic disk cartridge 1 out of the disk drive D, the drive gear 110 rotates the rotary shutter 40 in a closing direction thereof, and by the rotational movement, the engagement protrusion 42c of the rotary shutter 40 engages with the engagement hole portion 52 of the swing shutter 50, pushes and moves the swing shutter 50, and swings the shutter 50 counterclockwise in FIG. 7. By the swing movement the center hole C3 is closed by the swing shutter 50. At this time, as shown in FIG. 10B to FIG. 10A, the swing shutter 50 abuts on the conical face 61d of the center core 61 and pushes the magnetic disk medium DM into the cartridge case C. Then the center hole 61c of the center core 61 engages with the protrusion 31, and the magnetic disk medium DM is fixed within the cartridge case C.

In addition, the drive gear 110 retracts from the groove 18 where the state is changed from FIG. 9B to FIG. 9A; thereby, the engagement of the lock release leg portion 64c of the lock spring 64 with the gear 110 is released, the lock leg portion 64a of the lock spring 64 rotates clockwise in FIG. 7, engages in the driven gear 41a, and locks the rotation of the rotary shutter 40.

In accordance with the magnetic disk cartridge 1 of the embodiment thus described, the following effects are obtained.

Firstly, because the access opening C2 is not provided at the lower plate 20 and the upper plate 30, but is formed at a side portion, to be more precise, the side portion of the base frame 10, the opening of the cartridge case C suffices to be minimum and it is difficult for dust to invade the magnetic disk cartridge 1. In addition, because the magnetic disk cartridge 1 is enabled to only front the side face of the magnetic disk medium DM from the access opening C2 and not enabled to directly touch the recording face of the flexible disk FD with a hand and the like, it does not also occur to abruptly taint and damage the flexible disk FD. Accordingly, in the magnetic disk cartridge 1 an error is difficult to occur by the dust, and the taint and damage.

Because the rotary shutter 40 is disposed inside the base frame 10 and the outer perimeter of the shutter 40 is disposed more inside than the rim portions of the lower plate 20 and the upper plate 30, the shutter 40 is not hooked from outside and moved in no use of the magnetic disk cartridge 1.

In addition, because the swing shutter 50 is actuated inside the lower plate 20 and closes the center hole C3, it is not hooked by an outside thing and does not abruptly open. Particularly, because the swing shutter 50 is designed so as to close the center hole C3 with a single member, it is difficult to be hooked by an outside thing.

Because the ribs 14 formed around the base frame 10 are disposed at the perimeters of the lower plate 20 and the upper plate 30 and the height of the ribs 14 is larger than the thicknesses of the lower plate 20 and the upper plate 30, their rims 29 and 39 are not hooked into an outside thing.

Because the rotary shutter 40 contacts the lower plate 20 by the contact rib 41b formed along the circumference, a smooth rotational movement is enabled. Furthermore, because the part of the contact rib 41b is cut off not to prevent the swing movement of the swing shutter 50 and forms the window portion 41b′, the movement of the shutter 50 is also good.

In addition, the rotary shutter 40 has the reinforcement plate 42 at the side of the lower plate 20, a stable rotational movement is enabled.

Furthermore, the rotational movement of the rotary shutter 40 is transmitted to the swing movement of the swing shutter 50 by the engagement of the engagement protrusion 42c formed at the reinforcement plate 42 and the engagement hole portion 52 of the swing shutter 50, and the rotary shutter 40 and the swing shutter 50 can be simultaneously moved only by the operation of moving the rotary shutter 40 from outside. Although the engagement protrusion 42c slightly protrudes from the engagement hole portion 52 in some case, because an interference between the protruded portion and the lower plate 20 can be evaded by the evasion groove 22 formed at the lower plate 20, the smooth rotational movement of the rotary shutter 40 is ensured, and it is also enabled to prevent the occurrence of dust due to the contact of the engagement protrusion 42c and the lower plate 20.

Because the center core 61 engages in the protrusion 31 in no use of the magnetic disk cartridge 1, the magnetic disk medium DM is fixed and not damaged. Therefore, it is enabled to minimize a clearance between the magnetic disk medium DM and the base frame 10, to enlarge the size of the medium DM, and to enlarge a memory capacity thereof.

Because the access opening C2 is provided in an orthogonal direction for the insertion direction of the magnetic disk cartridge 1, right in the embodiment, it is enabled to dispose such the swing arm SA right and to lessen the depth of the disk drive D.

Because the chamfer portion C1 is formed at the corner at the front edge in the insertion direction of the cartridge case C into the disk drive D and the function discrimination member 66 is arranged on the chamfer portion C1, the disk drive D can receive the reflection light at a side thereof when the light is emitted from the front of the magnetic disk cartridge 1 and at a front thereof when the light is emitted from the side of the magnetic disk cartridge 1. In other words, this magnetic disk cartridge 1 allows the function discriminations member 66 to be accessible in two directions, namely, from the front and the side. As a result, the disk drive D can easily and surely provide the function discrimination in the magnetic disk cartridge 1.

The light reflection face 66b of the function discrimination member 66 provides discrimination in the insertion direction of the cartridge case C into the disk drive D and in the right face (upper/lower surface of the cartridge case C) by detecting the presence or the absence of the light reflected from the light reflection surface 66b.

Because the filter 66c for transmitting only a light component having a predetermined wavelength (band) is provided on the light reflection face 66b, use of one of various filters 66c provides a desired light component of a predetermined wavelength (band) from the light reflected by the light reflection face 66b. As a result, previously relating the function of the magnetic disk cartridge 1 with the wavelength of the reflection light provides discrimination in the function of the magnetic disk cartridge 1 on the basis of the wavelength (band) of the reflection light.

Because the chamfer portion C1 is arranged at the corner where the driven gear 41a and the groove 18 are not formed, when the magnetic disk cartridge is inserted into the disk drive D, function discrimination of the magnetic disk cartridge 1 can be easily and appropriately performed without interference with the drive gear 110.

Thus although one embodiment of the present invention is described, the invention can be carried out, changed as needed, and it goes without saying that the invention is not limited to the embodiment.

For example, the recording disk medium may also be optical disk medium such as magneto-optical disk medium and phase-change disk medium, not limited to magnetic disk medium; and disk medium having a rigidity such as a DVD-DRAM, not limited to flexible disk media.

In addition, although in the embodiment the swing shutter 50 is supported swingably by the lower plate 20, it may also be designed to be supported swingably by the upper plate 30 or the base frame 10.

In addition, the drive gear 110 is not limited to one fixed within the disk drive D, and may also be rotationally driven one.

Further, the function discrimination of the magnetic disk cartridge 1 is provided on the basis of the wavelength of the reflection light from the function discrimination member 66 (the light reflection face 66b). However, the function discrimination of the magnetic disk cartridge 1 may be provided on the basis of a reflectivity of the light reflection face 66b. More specifically, the function discrimination of the magnetic disk cartridge may be done on the basis of a ratio in intensity between the light emitted by the light emitter 113 and the reflection light.

Further, the function discrimination member 66 is not limited to the embodiment where the optical element is used, but may be provided with an RFID tag. When the RFID tag is arranged at the chamfer portion C1, the RFID tag is discriminated by access thereto in two directions, namely, from the front side and a side of the magnetic disk cartridge 1.

In the above-described embodiment, the base frame 10 of the magnetic disk cartridge 1 comprises a dovetail mechanism in the chamfer C1 for dovetailing the function discrimination member 66 with the magnetic disk cartridge 1.

Further, the dovetail mechanism comprises a slot extending in a direction perpendicular to an upper and lower face of the magnetic disk cartridge 1.

Further, the slot has openings at both sides (upper and lower sides) thereof to allow the function discrimination member 66 to slidingly fit in the slot in any of opposite directions along the slot.

Further, the discrimination member 66 has upper and lower faces which are flush with upper and lower faces of the magnetic disk cartridge and the filter 66c is flush with a surface of the chamfer C1.

Further, the filter 66c has the predetermined band which allows the light from the light emitter 113 to pass therethrough at the predetermined band and stops the light outside the predetermined band. The predetermined band is selected from a plurality of bands in accordance with the function that the recording disk cartridge has. The light receivers 114a and 114b are sensitive to the light within any of the predetermined bands. The discriminator 115 provides the discrimination in the function of the magnetic disk cartridge 1 on the basis of which one of the predetermined bands the wavelength of the received light exists in. For example, each of the light receivers 114a and 114b comprises a plurality of photo sensors having different filters to detect the band of the received light.

The light emitter 113 emits the light in a direction opposite to the insertion direction and is located at a position corresponding to the chamfer C1 in the insertion direction when the magnetic disk cartridge 1 is inserted to emit the light toward the chamber C1.

[Modifications]

In the above-described embodiment, the function discrimination member 66 comprises a light reflection face 66b and the filter (optical band-pass filter or a color filter) 66c. However, a dichroic mirror (not shown) may replace the light reflection face 66b and the filter 66c to selectively reflect the light from the light emitter 113.

The disk drive D may detect insertion of the magnetic disk cartridge 1. For example, the insertion of the magnetic disk cartridge 1 with an actuator (not shown) for detecting the insertion of the magnetic disk cartridge 1 and a mechanical switch (not shown) actuated by the actuator.

In the above-described embodiment, the light emitted by the light emitter 113 includes a plurality of light components having different wavelengths (bands), in which the light may be generated by combining a plurality of the light rays having different wavelengths such light from a red LED and a green LED. However, the light emitter 113 may be configured to emit light having a band continuously covering all pass bands of the color filters 66c indicating different functions used in the magnetic disk cartridge 1. For example, a white light source can be used.

The invention claimed is:

1. A recording disk cartridge including a recording disk medium and a cartridge case for housing the recording disk medium, comprising:
a base frame comprising:
sidewalls of the cartridge case for substantially surrounding a radial directional outside of the recording disk medium and;
a side opening for exposing the recording disk medium to the outside;
a lower plate disposed below the recording disk medium for configuring a lower wall of the cartridge case, the lower plate having a center hole for coupling a spindle of a disk drive to the recording disk medium;
an upper plate disposed above the recording disk medium for configuring an upper wall of the cartridge case;
a rotary shutter for opening and closing the side opening by a rotation movement thereof within the cartridge case;
a swing shutter disposed between the recording disk medium and the lower plate and engaging with the rotary shutter for swinging in response to a rotational movement of the rotary shutter to open and close the center hole;
a chamfer at a corner at a front of the cartridge case in an insertion direction of the cartridge case into the disk drive; and
a function discrimination member disposed at the chamfer for providing discrimination regarding the function of the recording disk cartridge.

2. The recording disk cartridge as claimed in claim 1, wherein the base frame comprises dovetail means in the chamfer for dovetailing the function discrimination member with the recording disk cartridge.

3. The recording disk cartridge as claimed in claim 2, wherein dovetail means comprises a slot extending in a direction perpendicular to an upper and lower face of the disk cartridge.

4. The recording disk cartridge as claimed in claim 3, wherein the slot has openings at both sides thereof to allow the function discrimination member to slidingly fit in the slot in any of opposite directions along the slot.

5. The recording disk cartridge as claimed in claim 1, wherein the function discrimination member comprises a reflection face.

6. The recording disk cartridge as claimed in claim 5, wherein the function discrimination member further comprises a filter for transmitting a light component only within a predetermined band.

7. The recording disk cartridge as claimed in claim 6, wherein the discrimination member has upper and lower faces which are flush with upper and lower faces of the recording disk cartridge, and the filter is flush with a surface of the chamfer.

8. The recording disk cartridge as claimed in claim 1, wherein the rotary shutter comprises a driven gear at an outer perimeter thereof for coupling a drive gear of the disk drive to perform the rotation movement, the base frame comprises, at one side of the base frame, a slot for introducing the drive gear to,the driven gear, and the corner is located at the other side of the base frame.

9. The recording disk cartridge as claimed in claim 1, wherein the chamfer is arranged at a corner at a front edge in the insertion direction of the recording disk cartridge into the disk drive.

10. The recording disk cartridge as claimed in claim 1, wherein the recording disk medium comprises a magnetic disk medium.

11. The recording disk cartridge as claimed in claim 1, wherein the recording disk medium comprises a magneto-optical disk medium.

12. The recording disk cartridge as claimed in claim 1, wherein the recording disk medium comprises a phase change optical disk medium.

13. The disk drive for driving the recording disk cartridge as claimed in claim 6, comprising:
a light emitter for emitting light including light components having different wavelengths toward the function discrimination member;
a light receiver for receiving the light from the light emitter via the function discrimination member;
a discriminator for providing discrimination in a function of the recording disk cartridge on the basis of a wavelength of the received light.

14. The disk drive as claimed in claim 13, wherein the predetermined band is selected from a plurality of bands in accordance with the function that the recording disk cartridge has, the light receiver is sensitive to the light within any of the predetermined bands, and the discriminator provides the discrimination in the function of the recording disk cartridge on the basis of which one of the predetermined bands the wavelength of the received light exists in.

15. The disk drive as claimed in claim 13, wherein the cartridge case comprises an inlet for receiving the recording disk cartridge, and the light receiver comprises:
a first light receiver for receiving the light reflected by the function discrimination member when the recording disk cartridge is located near the inlet; and
a second light receiver for receiving the light reflected by the function discrimination member when the recording disk cartridge is located at a position for driving the recording disk medium.

16. The disk drive as claimed in claim 13, wherein the discriminator detects that the recording disk cartridge is inserted, in which a right face thereof is correctly positioned for the disk driver in accordance with whether the light receiver receives the light.

17. The disk drive as claimed in claim 15, wherein the discriminator detects that the recording disk cartridge is inserted, in which a right face thereof is correctly positioned for the disk driver in accordance with whether the second light receiver receives the light.

18. The disk drive as claimed in claim 15, further comprising a head, wherein the rotary shutter allows the head to enter the recording disk cartridge through the side opening, wherein the discriminator determines that the rotary shutter opens the opening when the second light receiver receives the light.

19. The disk drive as claimed in claim 13, wherein the light emitter emits the light in a direction opposite to the insertion direction and is located at a position corresponding to the chamfer in the insertion direction when the recording disk cartridge is inserted to emit the light toward the chaffer.
